(19) United States
(12) Patent Application Publication
(10) Pub. No.: US 2018/0245850 A1
(43) Pub. Date: Aug. 30, 2018

(54) METHOD AND ARRANGEMENT FOR ADJUSTING CHARACTERISTICS OF A FURNACE PROCESS IN A FURNACE SPACE AND INJECTION UNIT

(71) Applicant: OUTOTEC (FINLAND) OY, Espoo (FI)

(72) Inventors: Peter BJÖRKLUND, Espoo (FI); Oskari KARHUVAARA, Espoo (FI); Valtteri SONNINEN, Helsinki (FI); Pekka SAARI, Kauniainen (FI); Matti LUOMALA, Pori (FI)

(73) Assignee: OUTOTEC (FINLAND) OY, Espoo (FI)

(21) Appl. No.: 15/758,425

(22) PCT Filed: Sep. 14, 2016
(86) PCT No.: PCT/FI2016/050634

§ 371 Date: Mar. 8, 2018

(30) Foreign Application Priority Data
Sep. 15, 2015 (FI) 20155660

(51) Int. Cl. F27D 3/18; F27B 3/18; F27D 21/00; F27D 19/00; F27D 11/08; F27B 14/12

(52) U.S. Cl. CPC F27D 3/18; F27B 3/18; F27D 21/00; F27D 19/00; F27B 2014/002; F27B 14/12; F27D 2003/185; F27D 2201/00; F27D 11/08

(57) ABSTRACT

Provided are a method and an arrangement for adjusting characteristics of a furnace process in a furnace space limited by a furnace shell of a metallurgical furnace. The arrangement comprises an injection unit having a frame mounted by means of a mounting means on the metallurgical furnace outside the furnace space of the furnace shell. Also provided is an injection unit for use in the method and in the arrangement.

### FIELD OF THE INVENTION

The invention relates to a method for adjusting characteristics of a furnace process in a furnace space limited by a furnace shell of a metallurgical furnace as defined in the preamble of independent claim 1.

The invention also relates to an arrangement for adjusting characteristics of a furnace process in a furnace space limited by a furnace shell of a metallurgical furnace as defined in the preamble of independent claim 7.

The invention relates also to an injection unit for use in the method and/or in the arrangement.

### OBJECTIVE OF THE INVENTION

The object of the invention is to provide a method and an arrangement for in a safe manner adjusting characteristics of a furnace process in a furnace space limited by a furnace shell of a metallurgical furnace and to provide an injection unit for use in the method and/or in the arrangement.

### SHORT DESCRIPTION OF THE INVENTION

The method for adjusting characteristics of a furnace process in a furnace space limited by a furnace shell of a metallurgical furnace of the invention is characterized by the definitions of independent claim 1.

Preferred embodiments of the method are defined in the dependent claims 2 to 6.

The arrangement for adjusting characteristics of a furnace process in a furnace space limited by a furnace shell of a metallurgical furnace of the invention is correspondingly characterized by the definitions of independent claim 7.

Preferred embodiments of the arrangement are defined in the dependent claims 8 to 12.

The injection unit for use in the method and/or in the arrangement is characterized by the definitions of independent claim 13.

Preferred embodiments of the injection unit are defined in the dependent claims 14 to 16.

The method and the arrangement and the injection unit allows a safe way of adjusting characteristics of a furnace process in a furnace space limited by a furnace shell of a metallurgical furnace. Safety is achieved, because the method and the arrangement and the injection unit provides for adding additives such as coke, pulverized coal, concentrate mixture, silica, lime, and limestone into the furnace space such as for injecting additives such coke, pulverized coal, concentrate mixture, silica, lime, and limestone into furnace melt that is inside furnace space without the operator having to be close to the furnace shell in order to add such additives, because the injection unit can be remotely operated by the operator for example by means of a process control system of the metallurgical furnace.

### LIST OF FIGURES

In the following the invention will described in more detail by referring to the figures, which

FIG. 1 shows a metallurgical furnace that is provided with an injection unit according to a first embodiment,

FIG. 2 shows a metallurgical furnace that is provided with an injection unit according to a second embodiment, and

FIGS. 3 and 4 shows the function principle of injection unit according to a first embodiment.

### DETAILED DESCRIPTION OF THE INVENTION

The invention relates to method and to an arrangement for adjusting characteristics of a furnace process in a furnace space 2 limited by a furnace shell 3 of a metallurgical furnace 4 and to an injection unit for use in the method and/or in the arrangement.

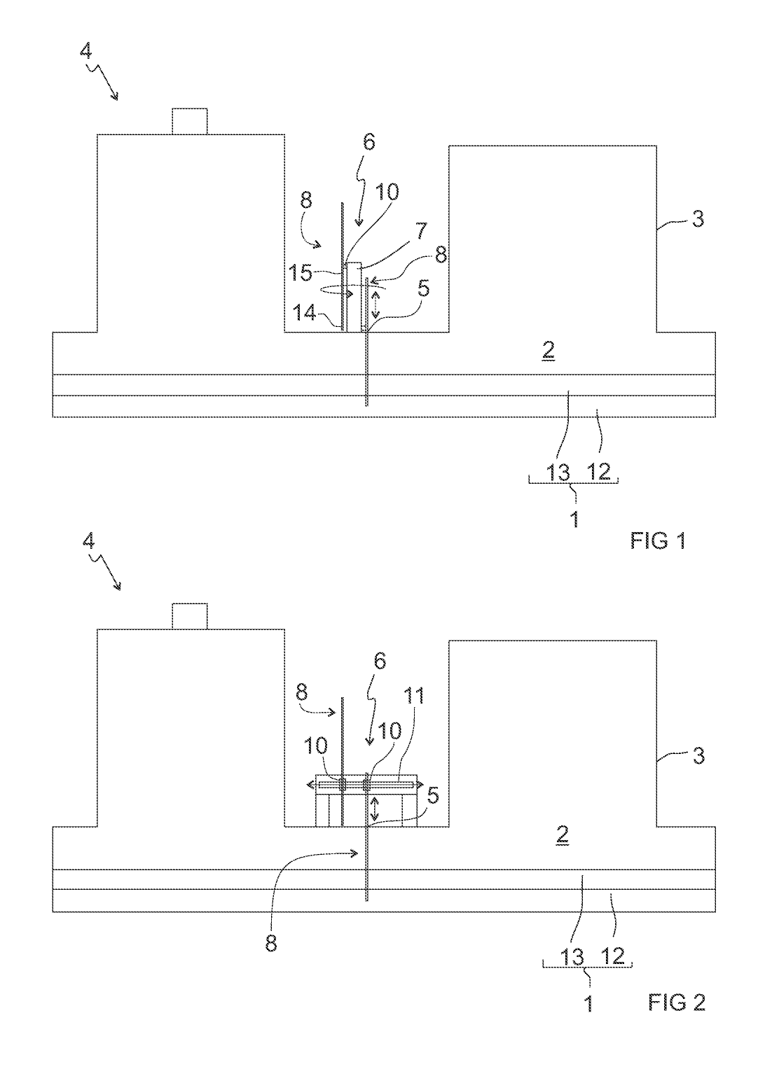

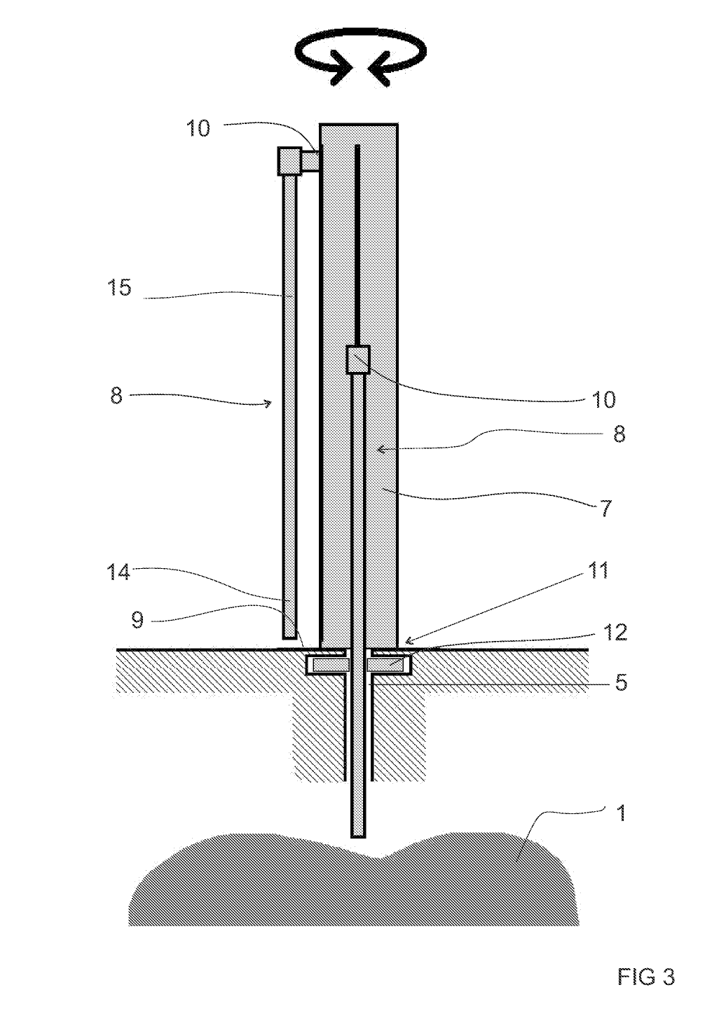

The metallurgical furnace 4 can for example be a suspension smelting furnace, an electric arc furnace, a top submerged lance furnace, or a bottom blown furnace. FIGS. 1 and 2 shows a metallurgical furnace 4 that is in the form of a suspension smelting furnace.

First the method for adjusting characteristics of a furnace process in a furnace space 2 limited by a furnace shell 3 of a metallurgical furnace 4 and some variants and embodiments of the method will be described in greater detail.

The method comprises a first providing step for providing a furnace aperture 5 extending through the furnace shell 3 of the metallurgical furnace 4.

The method comprises a second providing step for providing an injection unit 6 comprising a frame 7.

The injection unit 6 comprises at least one linearly movable injection device 8 that is configured to move linearly with respect to the frame 7 and that is configured to inject additives.

The injection unit 6 comprises mounting means 9 for mounting the frame 7 on the metallurgical furnace 4 outside the furnace space 2.

The injection unit 6 comprises first moving means 10 for moving said at least one linearly movable injection device 8 with respect to the frame 7, and second moving means 11 for moving said first moving means 10 between a first position and a second position with respect to the mounting means 9.

Said at least one linearly movable injection device 8 is preferably, but not necessarily, configured to move linearly for a predefined distance with respect to the frame 7.

The method comprises a mounting step for mounting the injection unit 6 by means of the mounting means 9 on the metallurgical furnace 4 outside the furnace space 2.

The method comprises a first moving step for moving said at least one linearly movable injection device 8 by means of the second moving means 11 with respect to the mounting means 9 from a first position, where said at least one linearly movable injection device 8 is unable linearly move through the furnace aperture 5 in the furnace shell 3, into a second position, where said at least one linearly movable injection device 8 is able linearly move through the furnace aperture 5 in the furnace shell 3.

The method comprises a second moving step for moving said at least one linearly movable injection device 8 by means of the first moving means 10 in said second position linearly through the furnace aperture 5 in the furnace shell 3 at least partly into the furnace space 2 and possible partly into furnace melt 1 in the furnace space 2, and an injections step for injecting additives into the furnace space 2 by means of said at least one linearly movable injection device 8 that is located at least partly inside the furnace space 2.

The method comprises a third moving step for moving said at least one linearly movable injection device 8 by means of the first moving means 10 in said second position through the furnace aperture 5 in the furnace shell 3 out of the furnace space 2.

The method comprises a fourth moving step for moving said at least one linearly movable injection device 8 by means of the second moving means 11 with respect to the mounting means 9 from said second position, where said at least one linearly movable injection device 8 is able linearly move through the furnace aperture 5 in the furnace shell 3, into a third position, where said at least one linearly movable injection device 8 is unable linearly move through the furnace aperture 5 in the furnace shell 3.

The third position may be the same as the first position or position different from the first position.

The method may comprise providing an injection unit 6 in the second providing step comprising a steering unit (not shown in the drawings) for automatically controlling at least the first moving means 10 and the second moving means 11, and the method may include automatically performing the first moving step, the second moving step, the third moving step, and the fourth moving step as controlled by the steering unit of the injection unit 6.

The injection unit 6 can be mounted in the mounting step by means of the mounting means 9 on at least one of a furnace roof of the furnace shell 3 of the metallurgical furnace 4, as shown in FIGS. 1 and 2, or on a furnace steel structure (not illustrated) above a furnace roof of the furnace shell 3 of the metallurgical furnace 4.

The method may include a third providing step for providing a hatch mechanism 12 for closing the furnace aperture 5 extending through the furnace shell 3, and a first connecting step for functionally connecting the hatch mechanism 12 with the injection unit 6 so that the hatch mechanism 12 is configured to open the furnace aperture 5 when the second moving means 11 of the injection unit 6 moves said at least one linearly movable injection device 8 into the second position and so that the hatch mechanism 12 is configured to close the furnace aperture 5 when the second moving means 11 of the injection unit 6 moves said at least one linearly movable injection device 8 from the second position into the third position.

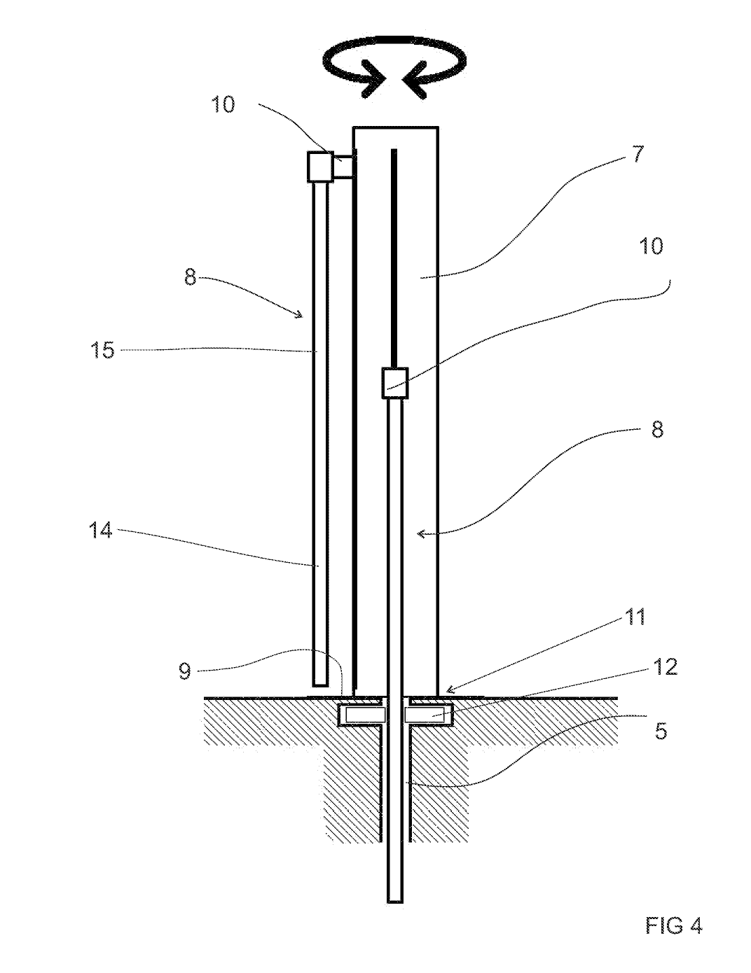

The method may include moving said at least one linearly movable injection device 8 between the first position and the second position in the first moving step by rotating said first moving means 10 with respect to the mounting means 9 and between the second position and the third position in the fourth moving step by rotating said first moving means 10 with respect to the mounting means 9. FIGS. 1, 3 and 4 shows such embodiments.

The method may include moving said at least one linearly movable injection device 8 between the first position and the second position in the first moving step linearly by moving said first moving means 10 linearly with respect to the mounting means 9, and between the second position and the third position in the fourth moving step linearly by moving said first moving means 10 linearly with respect to the mounting means 9. FIG. 2 shows such embodiment.

In an embodiment of the method, said at least one linearly movable injection device 8 of the injection unit 6 that is provided in the second providing step comprises an injection nozzle 14 and an elongated rod 15 having a distal end to which the injection nozzle 14 is attached.

In an embodiment of the method, at least one of coke, pulverized coal, concentrate mixture, silica, lime, limestone in injected into the furnace melt 1 inside the furnace space 2 in the injection step by means of said at least one linearly movable injection device 8.

In an embodiment of the method, at least one of coke, pulverized coal, concentrate mixture, silica, lime, and limestone in injected into the furnace space 2 in the injection step by means of said at least one linearly movable injection device 8.

In an embodiment of the method, the injection unit 6 that is provided comprises at least one of an electric motor, a pneumatic cylinder and a linear motor for linearly moving said at least one linearly movable injection device 8 between the first position and the second position in the first moving step and between the second position and the third position in the fourth moving step.

In an embodiment of the method, the injection unit 6 that is provided comprises at least one of an electric motor, a pneumatic cylinder and a linear motor for linearly moving said at least one linearly movable injection device 8 through the aperture 5 in the furnace shell 3.

In an embodiment of the method, the method comprises a connecting step for functionally connecting the injection unit 6 with a process control system of the metallurgical furnace 4.

In an embodiment of the method, the injection unit 6 that is provided in the second providing step comprise a linearly movable monitoring device (not shown in the figures) comprising at least one of a measuring device, a sampling device or an observing device for monitoring characteristics of the furnace process in the furnace space, third moving means (not shown in the figures) for linearly moving said at least one linearly movable monitoring device with respect to the frame 7, and fourth moving means (not shown in the figures) for moving said at least one linearly movable monitoring device between a fourth position and a fifth position with respect to the mounting means 9. This embodiment of the method comprises a fifth moving step for moving the third moving means by means of the fourth moving means with respect to the mounting means 9 from the fourth position into the fifth position, where the third moving means is able to move said at least one linearly movable monitoring device linearly through the furnace aperture 5 in the furnace shell 3. This embodiment of the method comprises a sixth moving step for moving said at least one linearly movable monitoring device by means of the third moving means in said fifth position linearly through the furnace aperture 5 in the furnace shell 3 at least partly into the furnace space 2, and a monitoring step for monitoring characteristics of the furnace process in the furnace space 2 by means of said at least one linearly movable monitoring device that is at least partly inside the furnace space 2. This embodiment of the method comprises a seventh moving step for moving said at least one linearly movable monitoring device by means of the third moving means in said fifth position linearly through the furnace aperture 5 in the furnace shell 3 out of the furnace space 2. This embodiment of the method comprises a eight moving step for moving the third moving means by means of the fourth moving means with respect to the mounting means 9 from the fifth position into a sixth position, where the third moving means is unable to linearly move said at least one linearly movable monitoring device linearly through the furnace aperture 5 in the furnace shell 3. Said at least one linearly movable monitoring device can comprise at least one of the following: a thermometer or an optical pyrometer for measuring temperature, a sampling chamber for measuring liquidus temperature of the furnace melt 1 inside the furnace space 2, a sounding rod configured to measure the level of the furnace melt 1 inside the furnace space 2 or configured to measure the thickness of a slag layer and/or of a molten metal layer of the furnace melt 1 inside the furnace space 2, a camera configured to take pictures inside the furnace space 2, a dust sampling device for taking dust samples inside the furnace space 2, a melt sampling device for taking melt samples from the furnace melt 1 inside the furnace space 2, and a gas sampling device for taking gas samples inside the furnace space 2.

Next the arrangement for adjusting characteristics of a furnace process in a furnace space 2 limited by a furnace shell 3 of a metallurgical furnace 4 and some variants and embodiments of the arrangement will be described in greater detail.

The arrangement comprises an injection unit 6 having a frame 7 mounted by means of a mounting means 9 on the metallurgical furnace 4 outside the furnace space 2.

The arrangement comprises a furnace aperture 5 extending through the furnace shell 3 of the metallurgical furnace 4.

The injection unit 6 comprises at least one linearly movable injection device 8 that is configured to move linearly with respect to the frame 7. Said at least one linearly movable injection device 8 is preferably, but not necessarily, configured to move linearly for a predefined distance with respect to the frame 7. The injection unit 6 comprises first moving means 10 for moving said at least one linearly movable injection device 8 linearly with respect to the frame 7.

The injection unit 6 comprises second moving means 11 for moving the first moving means 10 with respect to the mounting means 9 between a second position, where the first moving means 10 is able linearly move said at least one linearly movable injection device 8 linearly through the furnace aperture 5 in the furnace shell 3, and a first position, where the first moving means 10 is unable to move said at least one linearly movable injection device 8 linearly through the furnace aperture 5 in the furnace shell 3.

The third position may be the same as the first position or position different from the first position.

The injection unit 6 may comprise a steering unit (not shown in the drawings) for automatically adjusting at least the first moving means 10 and the second moving means 11.

In the embodiments shown in the figures, the injection unit 6 comprises two linearly movable injection devices 8, which are configured to move linearly with respect to the frame 7 and each of the linearly movable injection devices 8 are provided with first moving means 10 for moving the linearly movable injection device 8 with respect to the frame 7. If the injection unit 6 comprises several linearly movable injection devices 8, such as two linearly movable injection devices 8, each of the linearly movable injection devices 8 are preferably, but not necessarily, configured to inject a respective additive into the furnace space 2.

The injection unit 6 may be mounted on at least one of a furnace roof of the furnace shell 3, as shown in FIGS. 1 and 2, or a furnace steel structure above a furnace roof of the furnace shell 3.

The arrangement may comprise a hatch mechanism 12 for closing the furnace aperture 5, and the hatch mechanism 12 may be functionally connected with the injection unit 6 so that the hatch mechanism 12 is configured to open the furnace aperture 5 when the second moving means 11 of the injection unit 6 moves said at least one linearly movable injection device 8 into the second position and so that the hatch mechanism 12 is configured to close the furnace aperture 5 when the second moving means 11 of the injection unit 6 moves said at least one linearly movable injection device 8 from the second position.

The second moving means 11 may be configured to move the first moving means 10 between the first position and the second position by rotating.

The second moving means 11 may be configured to move the first moving means 10 between the first position and the second position linearly.

The injection unit 6 may comprise a linearly movable injection device 8 comprising an injection nozzle 14 and an elongated rod 15 having a distal end at which the injection nozzle 14 is attached.

Said at least one linearly movable injection device 8 may comprise an injection nozzle 15 configured to inject additives such as coke, pulverized coal, concentrate mixture, silica, lime, limestone into the furnace melt 1 inside the furnace space 2.

The injection unit 6 may comprise at least one of an electric motor, a pneumatic cylinder and a linear motor for linearly moving said at least one linearly movable injection device 8 through the aperture 5 in the furnace shell 3.

The injection unit 6 may be functionally connected with a process control system of the metallurgical furnace 4 for remotely operating the injection unit.

In an embodiment of the arrangement, the injection unit 6 comprises at least one linearly movable monitoring device comprising at least one of a measuring device, a sampling device or an observing device for monitoring characteristics of the furnace process in the furnace space 2.

In this embodiment of the arrangement, said at least one linearly movable monitoring device is configured to move linearly with respect to the frame 7. In this embodiment of the arrangement, the injection unit 6 comprises third moving means for moving said at least one linearly movable monitoring device with respect to the frame 7, and the injection unit 6 comprises fourth moving means for moving the third moving means with respect to the mounting means 9 between a fourth position, where said at least one linearly movable monitoring device is able linearly move through the furnace aperture 5 in the furnace shell 3, and a fifth position, where said at least one linearly movable monitoring device is unable to linearly move through the furnace aperture 5 in the furnace shell 3. Said at least one linearly movable monitoring device can comprise at least one of the following: a thermometer or an optical pyrometer for measuring temperature, a sampling chamber for measuring liquidus temperature of the furnace melt 1 inside the furnace space 2, a sounding rod configured to measure the level of the furnace melt 1 inside the furnace space 2 or configured to measure the thickness of a slag layer and/or of a molten metal layer of the furnace melt 1 inside the furnace space 2, a camera configured to take pictures inside the furnace space 2, a dust sampling device for taking dust samples inside the furnace space 2, a melt sampling device for taking melt samples from the furnace melt 1 inside the furnace space 2, and a gas sampling device for taking gas samples inside the furnace space 2.

Next the injection unit 6 for use in the method or in the arrangement and some variants and embodiments of the injection unit 6 will be described in greater detail.

The injection unit 6 comprises mounting means 9 for mounting a frame 7 of the injection unit 6 outside a furnace space 2 limited by a furnace shell 3 of a metallurgical furnace 4.

The injection unit 6 comprises at least one linearly movable injection device 8 that is configured to move linearly with respect to the frame 7 and that is configured to inject additives. The injection unit 6 comprises first moving means 10 for moving said at least one linearly movable injection device 8 with respect to the frame 7. Said at least one linearly movable injection device 8 is preferably, but not necessarily, configured to move linearly for a predefined distance with respect to the frame 7.

In the embodiments shown in the figures, the injection unit 6 comprises two linearly movable adjusting devices 8, which are configured to move linearly with respect to the frame 7 and each of the linearly movable adjusting devices 8 are provided with first moving means 10 for moving the linearly movable injection device 8 with respect to the frame 7. If the injection unit 6 comprises several linearly movable adjusting devices 8, such as two linearly movable adjusting devices 8, each of the linearly movable adjusting devices 8 are preferably, but not necessarily, configured to adjust a respective characteristic of a furnace process in the furnace space 2.

The injection unit 6 comprises second moving means 11 for moving said first moving means 10 with respect to the mounting means 9 between a first position and a second position. The second moving means 11 is preferably, but not necessarily, configured to move said first moving means 10 with respect to the mounting means 9 between a first position and a second position in a state, when said at least one linearly movable injection device 8 is positioned fully outside the furnace space 2.

The second moving means 11 may, as in the first embodiment shown in FIGS. 1, 3 and 4, be configured to move said first moving means 10 between the first position and the second position with respect to the mounting means 9 by rotating the frame 7 with respect to the mounting means 9.

The second moving means 11 may, as in the first embodiment shown in FIG. 2, be configured to move said first moving means 10 between the first position and the second position linearly with respect to the mounting means 9.

The injection unit 6 may comprise a linearly movable injection device 8 comprising an injection nozzle 14 and an elongated rod 15 having a distal end at which the injection nozzle 14 is attached.

The injection unit 6 may comprise a linearly movable injection device 8 comprising an injection device configured to inject additives such as coke, pulverized coal, concentrate mixture, silica, lime, limestone into the furnace melt 1 inside the furnace space 2.

The injection unit 6 may comprise at least one of an electric motor, a pneumatic cylinder and a linear motor for linearly moving said at least one linearly movable injection device 8 through the aperture 5 in the furnace shell 3.

The injection unit 6 comprises at least one of an electric motor, a pneumatic cylinder and a linear motor for moving the frame 7 with respect to the mounting means 9.

The injection unit 6 comprises at least one of an electric motor, a pneumatic cylinder and a linear motor for linearly moving said at least one linearly movable injection device 8 with respect to the frame 7.

In an embodiment of the injection unit 6, the injection unit 6 comprises at least one linearly movable monitoring device comprising at least one of a measuring device, a sampling device or an observing device for monitoring characteristics of the furnace process in the furnace space 2. In this embodiment of the injection unit 6, said at least one linearly movable monitoring device is configured to move linearly with respect to the frame 7. In this embodiment of the arrangement, the injection unit 6 comprises third moving means for moving said at least one linearly movable monitoring device with respect to the frame 7, and the injection unit 6 comprises fourth moving means for moving the third moving means with respect to the mounting means 9 between a fourth position and a fifth position. Said at least one linearly movable monitoring device can comprise at least one of the following: a thermometer or an optical pyrometer for measuring temperature, a sampling chamber for measuring liquidus temperature of the furnace melt 1 inside the furnace space 2, a sounding rod configured to measure the level of the furnace melt 1 inside the furnace space 2 or configured to measure the thickness of a slag layer and/or of a molten metal layer of the furnace melt 1 inside the furnace space 2, a camera configured to take pictures inside the furnace space 2, a dust sampling device for taking dust samples inside the furnace space 2, a melt sampling device for taking melt samples from the furnace melt 1 inside the furnace space 2, and a gas sampling device for taking gas samples inside the furnace space 2.

It is apparent to a person skilled in the art that as technology advances, the basic idea of the invention can be implemented in various ways. The invention and its embodiments are therefore not restricted to the above examples, but they may vary within the scope of the claims.

1-16. (canceled)

17. A method for adjusting characteristics of a furnace process in a furnace space limited by a furnace shell of a metallurgical furnace comprising:
a first providing step for providing a furnace aperture extending through the furnace shell,
a second providing step for providing an injection unit comprising a frame , at least one linearly movable injection device that is configured to move linearly with respect to the frame and that is configured to inject additives, mounting means for mounting the injection unit on the metallurgical furnace outside the furnace space, first moving means for linearly moving said at least one linearly movable injection device with respect to the frame, and second moving means for moving said at least one linearly movable injection device between a first position and a second position with respect to the mounting means,
a mounting step for mounting the injection unit by means of the mounting means on the metallurgical furnace outside the furnace space,
a first moving step for moving the first moving means by means of the second moving means with respect to the mounting means from the first position into the second position, where the first moving means is able to move said at least one linearly movable injection device linearly through the furnace aperture in the furnace shell,
a second moving step for moving said at least one linearly movable injection device by means of the first moving means in said second position linearly through the furnace aperture in the furnace shell at least partly into the furnace space, and an injection step for injecting additives into the furnace space by means of said at least one linearly movable injection device that is at least partly inside the furnace space,
a third moving step for moving said at least one linearly movable injection device by means of the first moving means in said second position linearly through the furnace aperture in the furnace shell out of the furnace space,
a fourth moving step for moving the first moving means by means of the second moving means with respect to the mounting means from the second position into a third position, where the first moving means is unable to linearly move said at least one linearly movable injection device linearly through the furnace aperture in the furnace shell, and
mounting the injection unit by means of the mounting means on at least one of a furnace roof or a furnace steel structure above the furnace roof of the furnace shell.

18. The method according to claim 17, further comprising
a third providing step for providing a hatch mechanism for closing the furnace aperture, and
a first connecting step for functionally connecting the hatch mechanism with the injection unit so that the hatch mechanism is configured to open the furnace aperture when the second moving means of the injection unit moves the first moving means into the second position and so that the hatch mechanism is configured to close the furnace aperture when the second moving means of the injection unit moves the first moving means from the second position.

19. The method according to claim 17, wherein
moving the second moving means between the first position and the second position is by rotating.

20. The method according to claim 17, wherein
the injection unit that is provided in the second providing step comprises a linearly movable monitoring device comprising at least one of a measuring device, a sampling device or an observing device for monitoring characteristics of the furnace process in the furnace space, third moving means for linearly moving said at least one linearly movable monitoring device with respect to the frame, and fourth moving means for moving said at least one linearly movable monitoring device between a fourth position and a fifth position with respect to the mounting means, and wherein the method further comprises:
a fifth moving step for moving the third moving means by means of the fourth moving means with respect to the mounting means from the fourth position into the fifth position, where the third moving means is able to move said at least one linearly movable monitoring device linearly through the furnace aperture in the furnace shell,
a sixth moving step for moving said at least one linearly movable monitoring device by means of the third moving means in said fifth position linearly through the furnace aperture in the furnace shell at least partly into the furnace space, and a monitoring step for monitoring characteristics of the furnace process in the furnace space by means of said at least one linearly movable monitoring device that is at least partly inside the furnace space,
a seventh moving step for moving said at least one linearly movable monitoring device by means of the third moving means in said fifth position linearly through the furnace aperture in the furnace shell out of the furnace space, and
an eighth moving step for moving the third moving means by means of the fourth moving means with respect to the mounting means from the fifth position into a sixth position, where the third moving means is unable to linearly move said at least one linearly movable monitoring device linearly through the furnace aperture in the furnace shell.

21. The method according to claim 17, wherein
said at least one linearly movable injection device comprising an injection nozzle is configured to inject at least one additive selected from the group consisting of coke, pulverized coal, concentrate mixture, silica, lime, and limestone into the furnace melt inside the furnace space.

22. An arrangement for adjusting characteristics of a furnace process in a furnace space limited by a furnace shell of a metallurgical furnace comprising:
an injection unit having a frame mounted by means of a mounting means on the metallurgical furnace outside the furnace space of the furnace shell, and
a furnace aperture extending through the furnace shell, wherein
the injection unit comprises at least one linearly movable injection device that is configured to move linearly with respect to the frame and a first moving means for moving said at least one linearly movable injection device with respect to the frame,
the injection unit comprises second moving means for moving the first moving means with respect to the mounting means between a first position, where said at least one linearly movable injection device is able linearly move through the furnace aperture in the furnace shell, and a second position, where said at least one linearly movable injection device in unable to linearly move through the furnace aperture in the furnace shell, and
the injection unit is mounted on at least one of a furnace roof of the furnace shell or a furnace steel structure above a furnace roof of the furnace shell.

23. The arrangement according to claim 22, wherein
the arrangement further comprises a hatch mechanism for closing the furnace aperture, and
the hatch mechanism is functionally connected with the injection unit so that the hatch mechanism is configured to open the furnace aperture in connection with moving the second moving means of the injection unit with the first moving means into the second position and so that the hatch mechanism is configured to close the furnace aperture in connection with moving the second moving means of the injection unit with the first moving means from the second position.

24. The arrangement according to claim 22, wherein
the second moving means is configured to move the first moving means between the first position and the second position by rotating.

25. The arrangement according to claim 22, wherein
the injection unit comprises at least one linearly movable monitoring device comprising at least one of a measuring device, a sampling device or an observing device for monitoring characteristics of the furnace process in the furnace space,
said at least one linearly movable monitoring device being configured to move linearly with respect to the frame,
the injection unit comprises third moving means for moving said at least one linearly movable monitoring device with respect to the frame, and
the injection unit comprises fourth moving means for moving the third moving means with respect to the mounting means between a fourth position, where said at least one linearly movable monitoring device is able to linearly move through the furnace aperture in the furnace shell, and a fifth position, where said at least one linearly movable monitoring device is unable to linearly move through the furnace aperture in the furnace shell.

26. The arrangement according to claim 22, wherein
the linearly movable injection device comprises an injection nozzle configured to inject at least one additive selected from the group consisting of coke, pulverized coal, concentrate mixture, silica, lime, and limestone into the furnace melt inside the furnace space.
